(19) United States
(12) Patent Application Publication
(10) Pub. No.: US 2026/0339596 A1
(43) Pub. Date: Oct. 29, 2026

(54) AUDIO PLAYBACK DEVICE

(71) Applicant: Anker Innovations Technology Co., Ltd., CHANGSHA (CN)

(72) Inventors: Xin ZHAO, SHENZHEN (CN); Qifang TONG, SHENZHEN (CN)

(73) Assignee: Anker Innovations Technology Co., Ltd., CHANGSHA (CN)

(21) Appl. No.: 19/661,714

(22) Filed: Apr. 29, 2026

(30) Foreign Application Priority Data
Apr. 29, 2025 (CN) 202520849893.0

(51) Int. Cl. G06F 3/16; H04R 3/00

(52) U.S. Cl. CPC G06F 3/162; H04R 3/00; H04R 2420/09

(57) ABSTRACT

An audio playback device configured to be connected to an electronic device includes: a first grounding pin; a first connector including a second grounding pin; a switch circuit connected between the first connector and the first grounding pin; a control chip connected to the first connector and the switch circuit; and a second connector. The first connector is configured to establish a connection with the electronic device and transmit an audio signal of the electronic device. The second connector is connected to the control chip and configured to establish a connection with the electronic device. In response to the first connector being in a connected state with the electronic device, the control chip controls the switch circuit based on a connection or a disconnection between the second connector and the electronic device, so that the first grounding pin is connected to or disconnected from the second grounding pin.

### CROSS-REFERENCE TO RELATED APPLICATIONS

The present application claims priority to Chinese Patent Application No. 202520849893.0, filed on Apr. 29, 2025, which is herein incorporated by reference in its entirety.

### TECHNICAL FIELD

The present disclosure relates to the field of electroacoustic technologies, and in particular to an audio playback device.

### BACKGROUND

A portable speaker may be connected to a computer through an AUX (auxiliary) interface to play music, and the speaker may also be connected to the same computer through an USB (universal serial bus) interface to charge the speaker. However, partial charging current may flow back from the AUX interface of the speaker to the computer through an AUX cable, resulting in increased noise in an AUX signal and producing noise floor. This phenomenon is particularly noticeable in scenarios involving high-power speakers.

### SUMMARY OF THE DISCLOSURE

In a first aspect, the present disclosure provides an audio playback device configured to be connected to an electronic device. The audio playback device includes a first grounding pin, a first connector, a switch circuit, a control chip, and a second connector. The first connector is configured to establish a connection with the electronic device and transmit an audio signal of the electronic device, and the first connector includes a second grounding pin. The switch circuit is connected between the first connector and the first grounding pin. The control chip is connected to the first connector and the switch circuit. The second connector is connected to the control chip and configured to establish a connection with the electronic device. In response to the first connector being in a connected state with the electronic device, the control chip controls the switch circuit based on a connection or a disconnection between the second connector and the electronic device, so that the first grounding pin is connected to or disconnected from the second grounding pin.

In some embodiments, in response to the first connector being in the connected state with the electronic device, and the second connector being in a connected state with the electronic device, the control chip controls the switch circuit to disconnect, so that the first grounding pin is disconnected from the second grounding pin. In response to the first connector being in the connected state with the electronic device, and the second connector being in a non-connected state with the electronic device, the control chip controls the switch circuit to conduct, so that the first grounding pin is connected to the second grounding pin.

In some embodiments, the second connector includes a third grounding pin. In response to the first connector being in the connected state with the electronic device, and the second connector being in the connected state with the electronic device, the control chip controls the switch circuit to disconnect, so that the first grounding pin is disconnected from the second grounding pin, and the first grounding pin is connected to the third grounding pin.

In some embodiments, the switch circuit includes a first switch sub-circuit and a second switch sub-circuit. The first switch sub-circuit is connected to the first connector and the first grounding pin, and the second switch sub-circuit is connected to the first switch sub-circuit and the control chip. The control chip controls the first switch sub-circuit to turn off by controlling conduction of the second switch sub-circuit, so that the first grounding pin is disconnected from the second grounding pin, and the first grounding pin is connected to the third grounding pin.

In some embodiments, the first connector includes an audio transmission pin, the control chip includes a first detection pin, and the first detection pin is connected to the audio transmission pin. In response to the first connector being in the connected state with the electronic device, the first detection pin is set to be at a high level.

In some embodiments, the first switch sub-circuit includes a first switch transistor, and the second switch sub-circuit includes a second switch transistor. A source electrode of the first switch transistor is connected to the first grounding pin, a drain electrode of the first switch transistor is connected to the second grounding pin, and a gate electrode of the first switch transistor is connected to a preset voltage terminal and the second switch transistor. A source electrode of the second switch transistor is connected to the first grounding pin, a drain electrode of the second switch transistor is connected to the gate electrode of the first switch transistor, and a gate electrode of the second switch transistor is connected to the control chip.

In some embodiments, the second connector includes a power supply voltage pin, the control chip includes a second detection pin, and the power supply voltage pin is connected to the second detection pin. In response to the second connector being in the connected state with the electronic device, the second detection pin is configured to be at a high level. In response to the second connector not being in the connected state with the electronic device, the second detection pin is configured to be at a low level.

In some embodiments, the control chip further includes a grounding configuration pin, and the grounding configuration pin is connected to the gate electrode of the second switch transistor. In response to the second detection pin being at the high level, the grounding configuration pin is set to be at the high level, so as to control conduction of the second switch transistor. In response to the second detection pin being at the low level, the grounding configuration pin is set to be at the low level, so as to control the second switch transistor to turn off.

In some embodiments, the second connector further includes a first differential signal pin and a second differential signal pin, the first differential signal pin and the second differential signal pin are respectively connected to the control chip, the first differential signal pin is configured for transmitting a first differential signal, and the second differential signal pin is configured for transmitting a second differential signal. The control chip performs enumeration through the first differential signal and the second differential signal, so as to obtain a connection state between the second connector and the electronic device.

In some embodiments, the first switch sub-circuit further includes a first resistor, wherein the gate electrode of the first switch transistor is connected to the preset voltage terminal through the first resistor. The second switch sub-circuit further includes a second resistor, and the gate electrode of the second switch transistor is connected to the first grounding pin through the second resistor.

In a second aspect, the present disclosure provides an audio playback device connected to an electronic device. The audio playback device includes a first grounding pin, a first connector, a switch circuit, a control chip, and a second connector. The first connector is configured to establish a connection with the electronic device and transmit an audio signal of the electronic device, and the first connector includes a second grounding pin. The switch circuit is connected between the first connector and the first grounding pin. The control chip is connected to the first connector and the switch circuit. The second connector is connected to the control chip and configured to establish a connection with the electronic device, so that the audio playback device is able to be charged by the electronic device through the second connector. In response to the first connector being in a connected state with the electronic device, the control chip controls the switch circuit based on a connection or a disconnection between the second connector and the electronic device, so that the first grounding pin is connected to or disconnected from the second grounding pin.

### BRIEF DESCRIPTION OF THE DRAWINGS

The present disclosure may be further described in conjunction with accompanying drawings and implementation methods. The accompanying drawings are as follows.

FIG. 1 is a structural schematic view of an audio playback device in an embodiment of the present disclosure.

FIG. 2 is a schematic view illustrating a grounding circuit of the audio playback device in an embodiment of the present disclosure.

FIG. 3 is a schematic view illustrating a grounding circuit of the audio playback device in another embodiment of the present disclosure.

FIG. 4 is a structural schematic view of the audio playback device in another embodiment of the present disclosure.

FIG. 5 is a schematic view illustrating a circuit of the audio playback device in an embodiment of the present disclosure.

### DETAILED DESCRIPTION

The reference to “embodiment” in the present disclosure means that, specific features, structures, or characteristics described in conjunction with some embodiments may be included in at least one embodiment of the present disclosure. The phrase appearing in various positions in the specification does not necessarily refer to the same embodiment, nor is it an independent or alternative embodiment that is mutually exclusive with other embodiments. Those of ordinary skill in the art explicitly and implicitly understand that the embodiments described in the present disclosure can be combined with other embodiments.

It should be understood that the term “and/or” used in the present disclosure is only used to describe a relationship between related objects, indicating that there may be three types of relationships. For example, A and/or B, which may represent: the existence of A alone, the existence of A and B at the same time, and the existence of B alone. In addition, the character “/” in the present disclosure generally indicates that the object before the character “/” and the object after the character “/” are in an “or” relationship. Moreover, the term “multiple” or “plurality” in the present disclosure refers to two or more. Further, the term “at least one” in the present disclosure refers to any one or any combination of at least two of multiple types. For example, including at least one of A, B, and C, which may represent: any one or more elements selected from the set consisting of A, B, and C. In addition, the terms “first”, “second”, and “third” in the present disclosure are only configured to describe and cannot be understood as indicating or implying relative importance or implicitly indicating the quantity of technical features indicated.

A portable speaker may be connected to a computer through an AUX (auxiliary) interface to play music, and the speaker may also be connected to the same computer through an USB (universal serial bus) interface to charge the speaker. However, partial charging current may flow back from the AUX interface of the speaker to the computer through an AUX cable, resulting in increased noise in an AUX signal and producing noise floor. At present, methods for solving the noise floor include using a resistor to isolate an AUX ground from the speaker’s main ground, which reduces the noise floor to a certain extent. However, noise may still be generated and increased during a variation of the charging current. Alternatively, diode isolation may be used to prevent the charging current from returning to the computer through the AUX interface ground, thereby solving a noise problem during charging. However, in a case where the AUX is only used to play music (i.e., without charging the speaker from the computer), due to the isolation of the diode, the computer and the speaker lack a common ground, which also increases the noise floor and affects the user experience.

Therefore, the present disclosure provides an audio playback device to solve the above problems.

In order to allow those of ordinary skill in the art to better understand technical solutions of the present disclosure, the technical solutions of the present disclosure may be described in detail in conjunction with the accompanying drawings and specific implementation methods.

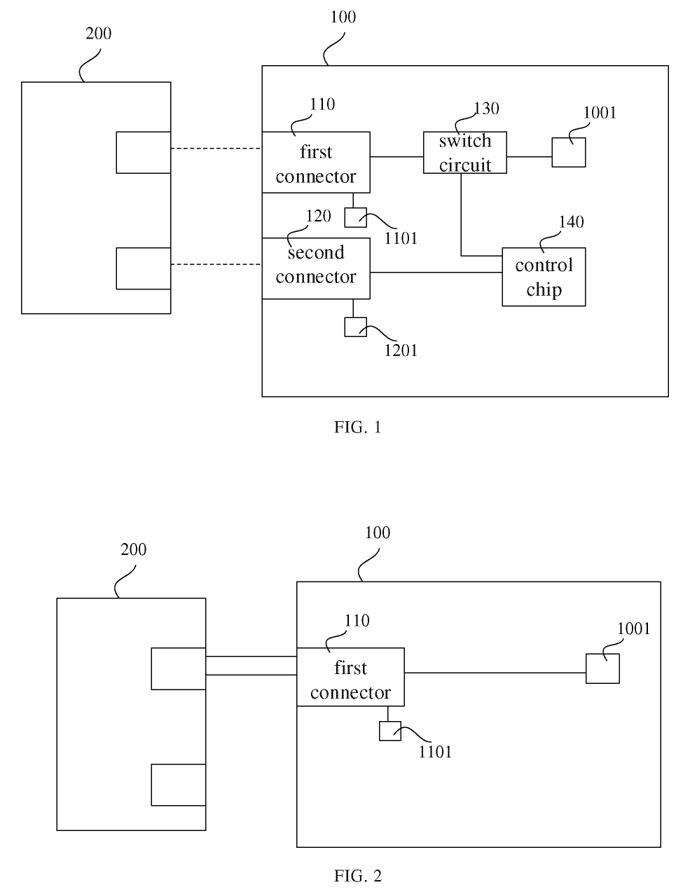

Referring to FIG. 1, FIG. 1 is a structural schematic view of an audio playback device in an embodiment of the present disclosure. An audio playback device 100 is connected to an electronic device 200. The audio playback device 100 includes a first grounding pin 1001, a first connector 110, a second connector 120, a switch circuit 130, and a control chip 140. The audio playback device 100 may be a portable speaker, the first grounding pin 1001 may be a ground (GND) of the audio playback device 100, the first connector 110 may be the AUX interface of the audio playback device 100 and configured for transmitting audio data, and the second connector 120 may be the USB interface of the audio playback device 100. The electronic device 200 may be a mobile device such as a computer.

In some embodiments, the audio playback device 100 may establish a connection with the electronic device 200 through the first connector 110, and transmit an audio signal of the electronic device 200 through the first connector 110. In some embodiments, the audio of the electronic device 200 is input through the first connector 110 for playback. The first connector 110 includes a second grounding pin 1101, such as a ground AUX_GND of the AUX interface. The switch circuit 130 is connected between the first connector 110 and the first grounding pin 1001. The control chip 140 is connected to the first connector 110 and the switch circuit 130. The second connector 120 is connected to the control chip 140 and configured for establishing a connection with the electronic device 200.

In response to the first connector 110 being in a connected state with the electronic device 200, the control chip 140 controls the switch circuit 130 based on a connection or a disconnection between the second connector 120 and the electronic device 200, so that the first grounding pin 1001 is connected to or disconnected from the second grounding pin 1101. In some embodiments, in response to the first connector 110 being in the connected state with the electronic device 200, the control chip 140 controls conduction or disconnection of the switch circuit 130 based on a connection state between the second connector 120 and the electronic device 200, thereby controlling connection or disconnection of the first grounding pin 1001 and the second grounding pin 1101.

In the present embodiment, the audio playback device 100 is connected to the electronic device 200. The audio playback device 100 includes the first grounding pin 1001, the first connector 110, the second connector 120, the switch circuit 130, and the control chip 140. In response to the first connector 110 being in the connected state with the electronic device 200, the control chip 140 controls the switch circuit 130 based on the connection or the disconnection between the second connector 120 and the electronic device 200, so that the first grounding pin 1001 is connected to or disconnected from the second grounding pin 1101, thereby solving a noise floor problem of the audio playback device 100 during audio playback and improving audio playback quality.

In some embodiments, in response to the first connector 110 being in the connected state with the electronic device 200, and the second connector 120 being in a connected state with the electronic device 200, the control chip 140 controls the switch circuit 130 to disconnect, so that the first grounding pin 1001 is disconnected from the second grounding pin 1101. In response to the first connector 110 being in the connected state with the electronic device 200, and the second connector 120 being in a non-connected state with the electronic device 200, the control chip 140 controls the switch circuit 130 to conduct, so that the first grounding pin 1001 is connected to the second grounding pin 1101.

In response to the first connector 110 being in the connected state with the electronic device 200, and the second connector 120 being in the connected state with the electronic device 200, the control chip 140 controls the switch circuit 130 to disconnect, so that the first grounding pin 1001 is disconnected from the second grounding pin 1101. In some embodiments, while the electronic device 200 performs the audio playback through the first connector 110 and simultaneously charges the audio playback device 100 through the second connector 120, the control chip 140 controls the switch circuit 130 to disconnect, so that the first grounding pin 1001 is disconnected from the second grounding pin 1101. This achieves common grounding between the audio playback device 100 and the electronic device 200 through the second connector 120, thereby blocking current from returning to the ground through an AUX transmission line of the audio playback device 100, and reducing AUX noise floor.

In some embodiments, in response to the first connector 110 being in the connected state with the electronic device 200, and the second connector 120 being in the non-connected state with the electronic device 200, the control chip 140 controls the switch circuit 130 to conduct, so that the first grounding pin 1001 is connected to the second grounding pin 1101. In some embodiments, the electronic device 200 only performs the audio playback through the first connector 110 and does not charge the audio playback device 100 through the second connector 120, the control chip 140 controls the switch circuit 130 to conduct, so that the first grounding pin 1001 is connected to the second grounding pin 1101, thereby maintaining electrical connection between the AUX_GND and the GND of the audio playback device 100, so as not to increase the noise floor during the audio playback.

The control chip 140 controls the switch circuit 130 based on the connection or the disconnection between the second connector 120 and the electronic device 200, so that the first grounding pin 1001 and the second grounding pin 1101 are connected or disconnected, changing a grounding mode of the audio device 100, thereby solving the noise floor problem of the audio playback device 100 during the audio playback and improving the audio playback quality.

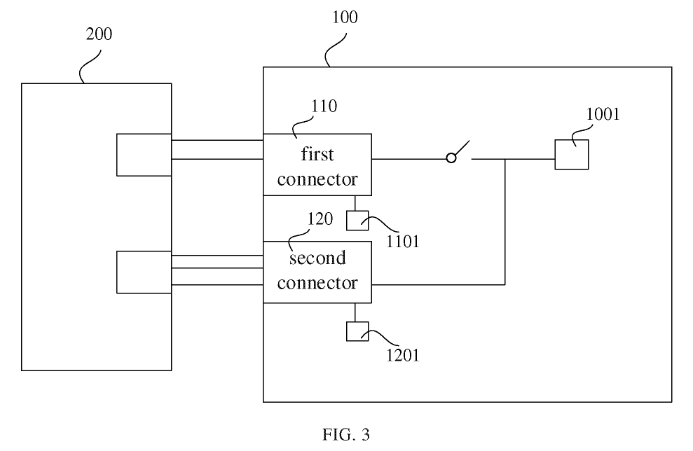

In some embodiments, the audio playback device 100 includes at least two playback modes, such as a music playback mode and a charging mode. The audio playback device 100 is in the music playback mode, as shown in FIG. 2, FIG. 2 is a schematic view illustrating a grounding circuit of the audio playback device in an embodiment of the present disclosure. That is, the first connector 110 is connected to the electronic device 200, and the second connector 120 is disconnected from the electronic device 200, the control chip 140 controls the switch circuit 130 to conduct, so that the first grounding pin 1001 is connected to the second grounding pin 1101. The audio playback device 100 is in both the music playback mode and the charging mode, as shown in FIG. 3, FIG. 3 is a schematic view illustrating a grounding circuit of the audio playback device in another embodiment of the present disclosure. That is, the first connector 110 is connected to the electronic device 200, and the second connector 120 is connected to the electronic device 200, the control chip 140 controls the switch circuit 130 to disconnect, so that the first grounding pin 1001 is disconnected from the second grounding pin 1101.

Referring to FIG. 1, in some embodiments, the second connector 120 includes a third grounding pin 1201, such as a ground USB_GND of the USB interface.

As shown in FIG. 3, in response to the first connector 110 being in the connected state with the electronic device 200, and the second connector 120 being in the connected state with the electronic device 200, that is, in response to the audio playback device 100 being in both the music playback mode and the charging mode, the control chip 140 controls the switch circuit 130 to disconnect, so that the first grounding pin 1001 is disconnected from the second grounding pin 1101, and the first grounding pin 1001 is connected to the third grounding pin 1201.

In the present embodiment of the present disclosure, in response to the first connector 110 being in the connected state with the electronic device 200, and the second connector 120 being in the connected state with the electronic device 200, the common grounding between the audio playback device 100 and the electronic device 200 is achieved through the third grounding pin 1201, thereby blocking the current from returning to the ground through the AUX transmission line of the audio playback device 100, and reducing the AUX noise floor.

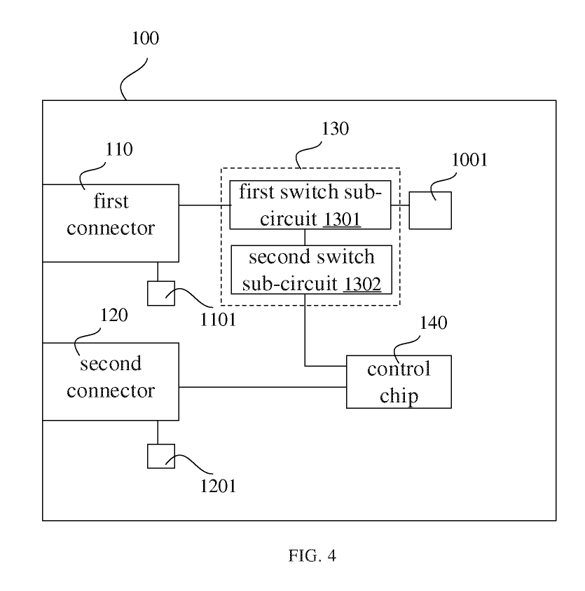

In some embodiments, as shown in FIG. 4, FIG. 4 is a structural schematic view of the audio playback device in another embodiment of the present disclosure. The switch circuit 130 includes a first switch sub-circuit 1301 and a second switch sub-circuit 1302. Each of the first switch sub-circuit 1301 and the second switch sub-circuit 1302 may include a NMOS (N-channel metal-oxide-semiconductor) transistor switch, a PMOS (P-channel metal-oxide-semiconductor) transistor switch, a load switch, or other devices.

The first switch sub-circuit 1301 is connected to the first connector 110 and the first grounding pin 1001, while the second switch sub-circuit 1302 is connected to the first switch sub-circuit 1301 and the control chip 140. The control chip 140 controls the first switch sub-circuit 1301 to turn off by controlling the conduction of the second switch sub-circuit 1302, thereby disconnecting the first grounding pin 1001 from the second grounding pin 1101 and connecting the first grounding pin 1001 to the third grounding pin 1201.

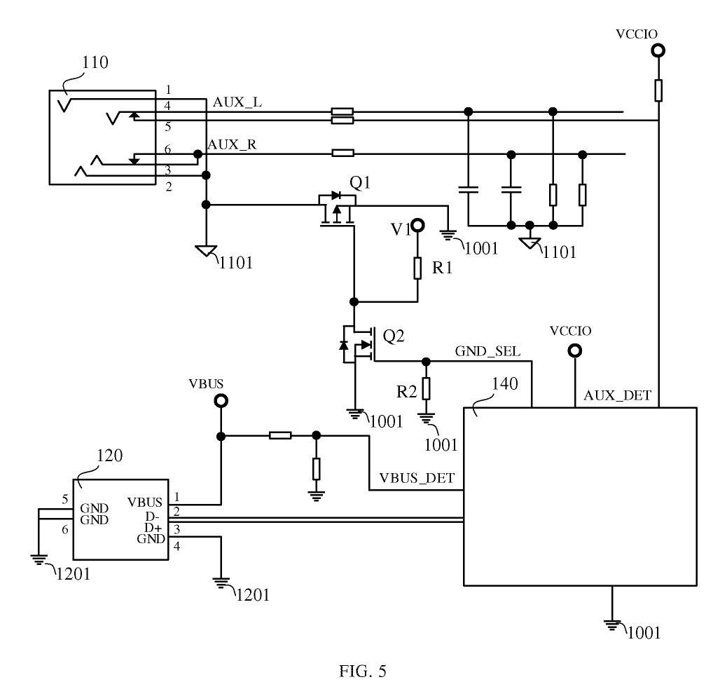

As shown in FIGS. 4-5, FIG. 5 is a schematic view illustrating a circuit of the audio playback device in an embodiment of the present disclosure. The switch circuit 130 includes the first switch sub-circuit 1301 and the second switch sub-circuit 1302. The first switch sub-circuit 1301 includes a first switch transistor Q1, and the second switch sub-circuit 1302 includes a second switch transistor Q2. The first switch transistor Q1 is connected to the first connector 110 and the first grounding pin 1001, and the second switch transistor Q2 is connected to the first switch transistor Q1 and the control chip 140. In some embodiments, the control chip 140 may control the first switch transistor Q1 to turn off by controlling the conduction of the second switch transistor Q2, thereby disconnecting the first grounding pin 1001 from the second grounding pin 1101 and maintaining the connection between the first grounding pin 1001 and the third grounding pin 1201.

In some embodiments, as shown in FIG. 5, a source electrode of the first switch transistor Q1 is connected to the first grounding pin 1001, a drain electrode of the first switch transistor Q1 is connected to the second grounding pin 1101, and a gate electrode of the first switch transistor Q1 is connected to a preset voltage terminal V1 and the second switch transistor Q2. A source electrode of the second switch transistor Q2 is connected to the first grounding pin 1001, a drain electrode of the second switch transistor Q2 is connected to the gate electrode of the first switch transistor Q1, and a gate electrode of the second switch transistor Q2 is connected to the control chip 140.

In some embodiments, the audio playback device 100 is in the music playback mode, the second switch transistor Q2 is non-conductive, the preset voltage terminal V1 is -3.3V, the gate electrode of the first switch transistor Q1 is connected to -3.3V and the second switch transistor Q2, and the first grounding pin 1001 is connected to the second grounding pin 1101, thereby maintaining electrical connection between the AUX_GND and the GND of the audio playback device 100, so as to reduce the noise floor during the audio playback.

In some embodiments, as shown in FIG. 5, the first connector 110 includes an audio transmission pin, such as a pin 5 of the first connector 110. The control chip 140 includes a first detection pin AUX_DET, and the first detection pin AUX_DET is connected to the audio transmission pin.

In response to the first connector 110 being in the connected state with the electronic device 200, the first detection pin AUX_DET is set to be at a high level. The control chip 140 detects a state of the first detection pin AUX_DET. In a case where the first detection pin AUX_DET is at the high level, it determines that the AUX interface is connected.

In some embodiments, as shown in FIG. 5, the second connector 120 includes a power supply voltage pin VBUS, the control chip 140 includes a second detection pin VBUS_DET, and the power supply voltage pin VBUS is connected to the second detection pin VBUS_DET. In response to the second connector 120 being in the connected state with the electronic device 200, the second detection pin VBUS_DET is configured to be at the high level. In response to the second connector 120 not being in the connected state with the electronic device 200, the second detection pin VBUS_DET is configured to be at a low level.

In some embodiments, the control chip 140 may determine the connection state between the first connector 110 and the electronic device 200, and the connection state between the second connector 120 and the electronic device 200 by detecting the states of the first detection pin AUX_DET and the second detection pin VBUS_DET. In some embodiments, in a case where both the USB interface and the AUX interface of the computer are inserted into the speaker, the second detection pin VBUS_DET is at the high level, and the control chip 140 detects that the USB interface of the computer is connected. Furthermore, the control chip 140 detects the state of the first detection pin AUX_DET. In a case where the first detection pin AUX_DET is at the high level, it determines that the AUX interface is connected.

In some embodiments, as shown in FIG. 5, the control chip 140 further includes a grounding configuration pin GND_SEL, and the grounding configuration pin GND_SEL is connected to the gate electrode of the second switch transistor Q2.

In response to the second detection pin VBUS_DET being at the high level, the grounding configuration pin GND_SEL is set to be at the high level, so as to control the conduction of the second switch transistor Q2. In some embodiments, the second detection pin VBUS_DET is at the high level, and the control chip 140 detects that the USB interface of the computer is connected. Furthermore, the control chip 140 sets the grounding configuration pin GND_SEL to be at the high level, so as to control the conduction of the second switch transistor Q2, so that the first switch transistor Q1 does not conduct. As a result, the first grounding pin 1001 is disconnected from the second grounding pin 1101, and the common grounding between the audio playback device 100 and the electronic device 200 is achieved through the second connector 120.

In some embodiments, in response to the second detection pin VBUS_DET being at the low level, the grounding configuration pin GND_SEL is set to be at the low level, so as to control the second switch transistor Q2 to turn off. In some embodiments, the second detection pin VBUS_DET is at the low level, and the control chip 140 sets the grounding configuration pin GND_SEL to be at the low level, so as to control the second switch transistor Q2 to remain non-conductive. In this case, the first switch transistor Q1 conducts, that is, the first grounding pin 1001 is connected to the second grounding pin 1101, thereby maintaining electrical connection between the AUX_GND and the GND of the audio playback device 100.

In some embodiments, as shown in FIG. 5, the second connector 120 further includes a first differential signal pin D+ and a second differential signal pin D-. The first differential signal pin D+ and the second differential signal pin D- are respectively connected to the control chip 140. The first differential signal pin D+ is configured to transmit a first differential signal, and the second differential signal pin D- is configured to transmit a second differential signal. The control chip 140 performs enumeration through the first differential signal and the second differential signal, so as to obtain the connection state between the second connector 120 and the electronic device 200.

In USB communication, enumeration refers to the process in which a host identifies, configures, and activates a device through a series of standardized operations in a case where a USB device is connected to the host. In some embodiments, by pulling up D+ (full-speed/high-speed) or D- (low-speed) using a pull-up resistor (1.5kΩ), the host detects the level change, so as to identify the device insertion and the speed mode. In some embodiments, the second detection pin VBUS_DET is at the high level, and the control chip 140 enumerates the USB through D+/D-. In a case where the enumeration is successful, it determines that the second connector 120 is successfully connected to the electronic device 200. Furthermore, the control chip 140 sets the grounding configuration pin GND_SEL to be at the high level, so as to control the second switch transistor Q2 to conduct, so that the first switch transistor Q1 remains non-conductive. Therefore, the first grounding pin 1001 is disconnected from the second grounding pin 1101, the common grounding between the audio playback device 100 and the electronic device 200 is achieved through the second connector 120.

In some embodiments, as shown in FIG. 5, the first switch sub-circuit 1301 further includes a first resistor R1, and the gate electrode of the first switch transistor Q1 is connected to the preset voltage terminal V1 through the first resistor R1. An end of the first resistor R1 is connected to the gate electrode of the first switch transistor Q1, and another end of the first resistor R1 is connected to the preset voltage terminal V1, thereby improving stability and reliability of the circuit.

In some embodiments, as shown in FIG. 5, the second switch sub-circuit 1302 further includes a second resistor R2, and the gate electrode of the second switch transistor Q2 is connected to the first grounding pin 1001 through the second resistor R2. An end of the second resistor R2 is connected to the gate electrode of the second switch transistor Q2, and another end of the second resistor R2 is connected to the first grounding pin 1001, thereby improving the stability and the reliability of the circuit.

The effects of the present disclosure are as follows. The audio playback device is connected to the electronic device. The audio playback device includes the first grounding pin, the first connector, the second connector, the switch circuit, and the control chip. In response to the first connector being in the connected state with the electronic device, the control chip controls the switch circuit based on the connection or the disconnection between the second connector and the electronic device, so that the first grounding pin is connected to or disconnected from the second grounding pin, thereby solving a noise floor problem of the audio playback device during audio playback and improving audio playback quality.

The above descriptions of various embodiments tend to emphasize differences between the embodiments. The same or similar aspects thereof may be cross-referenced with each other, and for the sake of simplicity, may not be repeated in the present disclosure.

In some embodiments of the present disclosure, disclosed methods and related devices may be implemented in other ways. For example, the implementation of the relevant devices described above are only illustrative. For example, the division of modules or units is only a logical function division. In actual implementation, there may be another division mode. For example, units or components may be combined or integrated into another system, some features may be ignored, or some operations may not be executed. On the other hand, the displayed or discussed mutual coupling, direct coupling, or communication connection may be indirect coupling or communication connection through some interfaces, devices, or units, and may be in electrical, mechanical, or other forms.

Those of ordinary skill in the art may easily understand that various modifications and changes to the device and method may be made while maintaining the teaching content of the present disclosure. Therefore, the above disclosure should be considered as being limited only by the scope of the appended claims.

1. An audio playback device, configured to be connected to an electronic device, and comprising:
a first grounding pin;
a first connector, configured to establish a connection with the electronic device and transmit an audio signal of the electronic device, wherein the first connector comprises a second grounding pin;
a switch circuit, connected between the first connector and the first grounding pin;
a control chip, connected to the first connector and the switch circuit; and
a second connector, connected to the control chip and configured to establish a connection with the electronic device;
wherein in response to the first connector being in a connected state with the electronic device, the control chip controls the switch circuit based on a connection or a disconnection between the second connector and the electronic device, so that the first grounding pin is connected to or disconnected from the second grounding pin.

2. The audio playback device according to claim 1, wherein in response to the first connector being in the connected state with the electronic device, and the second connector being in a connected state with the electronic device, the control chip controls the switch circuit to disconnect, so that the first grounding pin is disconnected from the second grounding pin; and
in response to the first connector being in the connected state with the electronic device, and the second connector being in a non-connected state with the electronic device, the control chip controls the switch circuit to conduct, so that the first grounding pin is connected to the second grounding pin.

3. The audio playback device according to claim 2, wherein the second connector comprises a third grounding pin; and
in response to the first connector being in the connected state with the electronic device, and the second connector being in the connected state with the electronic device, the control chip controls the switch circuit to disconnect, so that the first grounding pin is disconnected from the second grounding pin, and the first grounding pin is connected to the third grounding pin.

4. The audio playback device according to claim 3, wherein the switch circuit comprises a first switch sub-circuit and a second switch sub-circuit;
the first switch sub-circuit is connected to the first connector and the first grounding pin, and the second switch sub-circuit is connected to the first switch sub-circuit and the control chip; and
the control chip controls the first switch sub-circuit to turn off by controlling conduction of the second switch sub-circuit, so that the first grounding pin is disconnected from the second grounding pin, and the first grounding pin is connected to the third grounding pin.

5. The audio playback device according to claim 4, wherein the first connector comprises an audio transmission pin, the control chip comprises a first detection pin, and the first detection pin is connected to the audio transmission pin; and
in response to the first connector being in the connected state with the electronic device, the first detection pin is set to be at a high level.

6. The audio playback device according to claim 4, wherein the first switch sub-circuit comprises a first switch transistor, and the second switch sub-circuit comprises a second switch transistor;
a source electrode of the first switch transistor is connected to the first grounding pin, a drain electrode of the first switch transistor is connected to the second grounding pin, and a gate electrode of the first switch transistor is connected to a preset voltage terminal and the second switch transistor; and
a source electrode of the second switch transistor is connected to the first grounding pin, a drain electrode of the second switch transistor is connected to the gate electrode of the first switch transistor, and a gate electrode of the second switch transistor is connected to the control chip.

7. The audio playback device according to claim 6, wherein the second connector comprises a power supply voltage pin, the control chip comprises a second detection pin, and the power supply voltage pin is connected to the second detection pin;
in response to the second connector being in the connected state with the electronic device, the second detection pin is configured to be at a high level; and
in response to the second connector not being in the connected state with the electronic device, the second detection pin is configured to be at a low level.

8. The audio playback device according to claim 7, wherein the control chip further comprises a grounding configuration pin, and the grounding configuration pin is connected to the gate electrode of the second switch transistor;
in response to the second detection pin being at the high level, the grounding configuration pin is set to be at the high level, so as to control conduction of the second switch transistor; and
in response to the second detection pin being at the low level, the grounding configuration pin is set to be at the low level, so as to control the second switch transistor to turn off.

9. The audio playback device according to claim 7, wherein the second connector further comprises a first differential signal pin and a second differential signal pin, the first differential signal pin and the second differential signal pin are respectively connected to the control chip, the first differential signal pin is configured for transmitting a first differential signal, and the second differential signal pin is configured for transmitting a second differential signal; and
the control chip performs enumeration through the first differential signal and the second differential signal, so as to obtain a connection state between the second connector and the electronic device.

10. The audio playback device according to claim 6, wherein the first switch sub-circuit further comprises a first resistor, wherein the gate electrode of the first switch transistor is connected to the preset voltage terminal through the first resistor; and
the second switch sub-circuit further comprises a second resistor, and the gate electrode of the second switch transistor is connected to the first grounding pin through the second resistor.

11. An audio playback device, configured to be connected to an electronic device, and comprising:
a first grounding pin;
a first connector, configured to establish a connection with the electronic device and transmit an audio signal of the electronic device, wherein the first connector comprises a second grounding pin;
a switch circuit, connected between the first connector and the first grounding pin;
a control chip, connected to the first connector and the switch circuit; and
a second connector, connected to the control chip and configured to establish a connection with the electronic device, so that the audio playback device is able to be charged by the electronic device through the second connector;
wherein in response to the first connector being in a connected state with the electronic device, the control chip controls the switch circuit based on a connection or a disconnection between the second connector and the electronic device, so that the first grounding pin is connected to or disconnected from the second grounding pin.

12. The audio playback device according to claim 11, wherein in response to the first connector being in the connected state with the electronic device, and the second connector being in a connected state with the electronic device, the control chip controls the switch circuit to disconnect, so that the first grounding pin is disconnected from the second grounding pin; and
in response to the first connector being in the connected state with the electronic device, and the second connector being in a non-connected state with the electronic device, the control chip controls the switch circuit to conduct, so that the first grounding pin is connected to the second grounding pin.

13. The audio playback device according to claim 12, wherein the second connector comprises a third grounding pin; and
in response to the first connector being in the connected state with the electronic device, and the second connector being in the connected state with the electronic device, the control chip controls the switch circuit to disconnect, so that the first grounding pin is disconnected from the second grounding pin, and the first grounding pin is connected to the third grounding pin.

14. The audio playback device according to claim 13, wherein the switch circuit comprises a first switch sub-circuit and a second switch sub-circuit;
the first switch sub-circuit is connected to the first connector and the first grounding pin, and the second switch sub-circuit is connected to the first switch sub-circuit and the control chip; and
the control chip controls the first switch sub-circuit to turn off by controlling conduction of the second switch sub-circuit, so that the first grounding pin is disconnected from the second grounding pin, and the first grounding pin is connected to the third grounding pin.

15. The audio playback device according to claim 14, wherein the first connector comprises an audio transmission pin, the control chip comprises a first detection pin, and the first detection pin is connected to the audio transmission pin; and
in response to the first connector being in the connected state with the electronic device, the first detection pin is set to be at a high level.

16. The audio playback device according to claim 14, wherein the first switch sub-circuit comprises a first switch transistor, and the second switch sub-circuit comprises a second switch transistor;
a source electrode of the first switch transistor is connected to the first grounding pin, a drain electrode of the first switch transistor is connected to the second grounding pin, and a gate electrode of the first switch transistor is connected to a preset voltage terminal and the second switch transistor; and
a source electrode of the second switch transistor is connected to the first grounding pin, a drain electrode of the second switch transistor is connected to the gate electrode of the first switch transistor, and a gate electrode of the second switch transistor is connected to the control chip.

17. The audio playback device according to claim 16, wherein the second connector comprises a power supply voltage pin, the control chip comprises a second detection pin, and the power supply voltage pin is connected to the second detection pin;
in response to the second connector being in the connected state with the electronic device, the second detection pin is configured to be at a high level; and
in response to the second connector not being in the connected state with the electronic device, the second detection pin is configured to be at a low level.

18. The audio playback device according to claim 17, wherein the control chip further comprises a grounding configuration pin, and the grounding configuration pin is connected to the gate electrode of the second switch transistor;
in response to the second detection pin being at the high level, the grounding configuration pin is set to be at the high level, so as to control conduction of the second switch transistor; and
in response to the second detection pin being at the low level, the grounding configuration pin is set to be at the low level, so as to control the second switch transistor to turn off.

19. The audio playback device according to claim 17, wherein the second connector further comprises a first differential signal pin and a second differential signal pin, the first differential signal pin and the second differential signal pin are respectively connected to the control chip, the first differential signal pin is configured for transmitting a first differential signal, and the second differential signal pin is configured for transmitting a second differential signal; and
the control chip performs enumeration through the first differential signal and the second differential signal, so as to obtain a connection state between the second connector and the electronic device.

20. The audio playback device according to claim 16, wherein the first switch sub-circuit further comprises a first resistor, wherein the gate electrode of the first switch transistor is connected to the preset voltage terminal through the first resistor; and
the second switch sub-circuit further comprises a second resistor, and the gate electrode of the second switch transistor is connected to the first grounding pin through the second resistor.
